(19) United States
(12) Patent Application Publication
(10) Pub. No.: US 2012/0278050 A1
(43) Pub. Date: Nov. 1, 2012

(54) Accelerated Generation of Circuit Parameter Distribution Using Monte Carlo Simulation

(75) Inventors: Cheng Hsiao, Hsin-Chu (TW); Ke-Wei Su, Zhubei City (TW); Chung-Kai Lin, Taipei (TW); Min-Chie Jeng, Taipei (TW)

(73) Assignee: Taiwan Semiconductor Manufacturing Company, Ltd., Hsin-Chu (TW)

(21) Appl. No.: 13/097,569

(22) Filed: Apr. 29, 2011

(51) Int. Cl. G06G 7/62; G06F 17/10

(52) U.S. Cl. 703/2; 703/13

(57) ABSTRACT

A method includes providing an integrated circuit device comprising a plurality of input parameters and an electrical parameter. A simulation is performed using a simulation model to simulate a plurality of data of the electrical parameter, wherein the plurality of data are generated through simulation from a first plurality of input parameter sets reflecting values of the plurality of input parameters, and wherein the plurality of data is distributed in a range. A first sub-range among the range is selected. All of the plurality of data falling into the first sub-range are selected, and are fitted with corresponding ones of the first input parameter sets to generate a first function, wherein the electrical parameter is expressed as the first function of the plurality of input parameters. The first function is different from functions in the simulation model.

### BACKGROUND

For designers to design integrated circuits, the characteristics of the integrated circuits need to be predicted. For example, the distribution of the electrical performance of integrated circuits needs to be known so that the designed integrated circuits may have adequate, but not excessive, margin to meet design requirements.

Conventionally, the characteristics of the integrated circuits may be obtained through Monte Carlo simulations. Although Monte Carlo simulations may reflect the circuit characteristics relatively accurately, the time for performing the Monte Carlo simulations may be too long, and may sometimes take months for some integrated circuits. On the other hand, there were no available methods that can quickly provide accurate results without introducing large variance. For example, although linear extrapolation appears to be an available method, the accuracy of the simulation results using the linear extrapolation is low.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 illustrates small-sample parameter sets of an integrated circuit device, wherein each of the small-sample parameter sets includes values of input parameters P1 through P30, and wherein the small-sample parameter sets have a uniform distribution;

FIG. 2 schematically illustrates the generation of an output parameter (Icell) through Monte Carlo simulation, wherein a plurality of values of the output parameter is generated, with each of the plurality of values generated from one of the small-sample parameter sets as shown in FIG. 1;

FIG. 3 illustrates the distribution of output parameter Icell, wherein the distribution range of the Icell is divided into a plurality of sub-ranges;

FIG. 4 illustrates a large-sample parameter set of the integrated circuit device, wherein each of the large-sample parameter sets includes values of input parameters P1 through P30, and wherein the large-sample parameter sets have a Gaussian distribution;

FIG. 5 illustrates the distribution of Icell values calculated from an equation obtained using Icell values in sub-range R1 in FIG. 3, wherein the calculated Icell values in sub-range R1 are selected to form a new group of data, while the calculated Icell values falling out of sub-range R1 are discarded;

FIG. 6 illustrates the cumulative density function (CDF) as a function of calculated Icell values;

FIG. 7 illustrates the distribution of Icell values calculated from equations obtained using Icell values in sub-range R2 in FIG. 3, wherein the calculated Icell values in sub-range R2 are selected, while the calculated Icell values out of sub-range R2 are discarded;

FIG. 8 illustrates the CDF as a function of calculated Icell values, with the equation used for generating the calculated Icell values corresponds to sub-range R2;

FIG. 9 illustrates the CDF as a function of calculated Icell values, with the equation used for generating the calculated Icell values corresponds to sub-range RL;

FIG. 10 illustrates the assembled CDF line, wherein the calculated Icell values reflected by the assembled CDF line are the selected Icell values from each of the sub-ranges; and

FIG. 11 schematically illustrates a static random access (SRAM) cell, which is used as an example of the simulated integrated circuit device.

### DETAILED DESCRIPTION OF ILLUSTRATIVE EMBODIMENTS

The making and using of the embodiments of the disclosure are discussed in detail below. It should be appreciated, however, that the embodiments provide many applicable inventive concepts that can be embodied in a wide variety of specific contexts. The specific embodiments discussed are merely illustrative, and do not limit the scope of the disclosure.

A method for rapidly simulating the performance of integrated circuits is provided in accordance with an embodiment. The intermediate stages of the embodiment are illustrated. The variations of the embodiment are discussed. Throughout the various views and illustrative embodiments, like reference numbers are used to designate like elements.

Throughout the description, a static random access memory (SRAM) cell as shown in FIG. 11 is used to explain the concept of embodiments. It is realized, however, that all other integrated circuit devices may also be simulated using the teaching of the embodiments. In FIG. 11, SRAM cell 20 includes six transistors 22A through 22F. Assuming each of transistors 22A through 22F has five input parameters that are to be simulated to generate an output parameter, which is cell current Icell in an example, then there are in total 5+6, which is 30, input parameters. In the following discussed exemplary embodiments, the input parameters are expressed as P1 through P30. The output parameter may be an electrical parameter such as cell current Icell of the SRAM cell. The value of the output parameter is the function of the values of input parameters P1 through P30.

In the embodiments, a layout of the SRAM cell is provided. The input parameters P1 through P30 may include, and are not limited to, the layout parameters such as the thicknesses of gate oxides, gate lengths, gate widths, and the like, of transistors 22A through 22F. Accordingly, the distribution of input parameters P1 through P30 reflects the variation of the layout parameters.

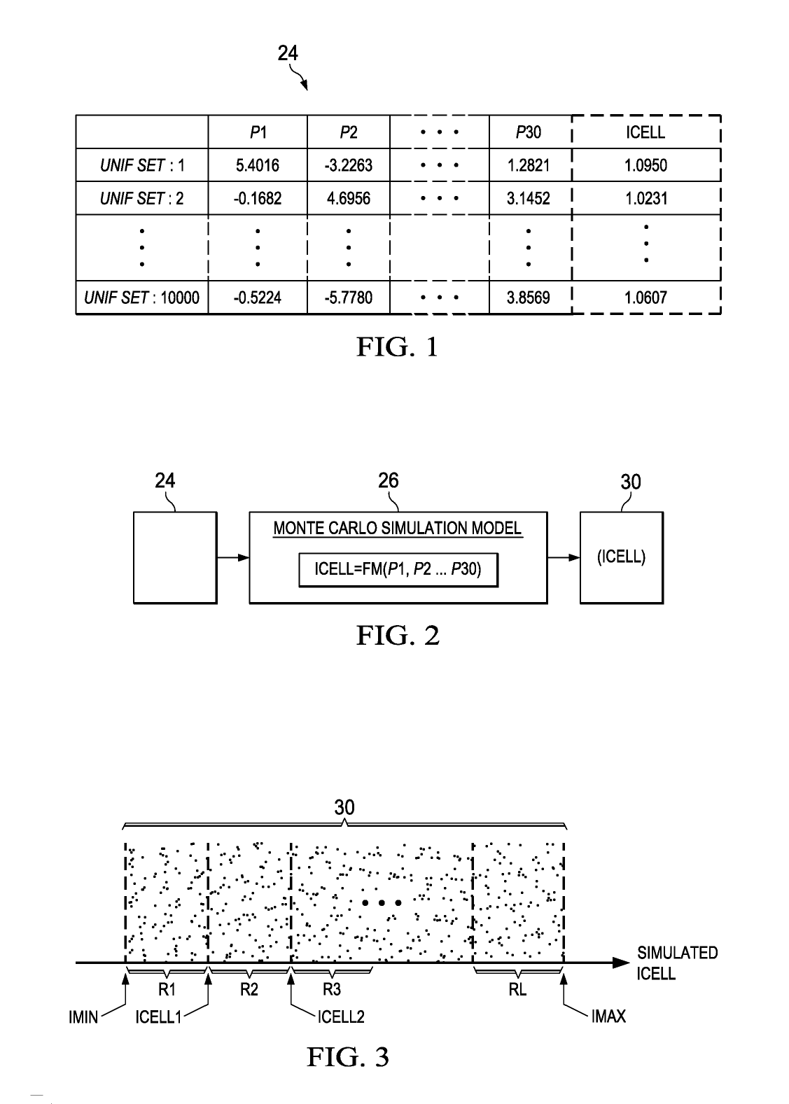

Referring to FIG. 1, a first plurality of input parameter sets 24 (denoted as UNIF set 1 through UNIF set 10000) are generated. Throughout the description, input parameter sets 24 are referred to small-sample input parameter sets since the total number of the input parameter sets is relatively small. In the discussed exemplary embodiment, there are 10,000 small-sample input parameter sets, although any other number may be used. In an embodiment, each of the values of input parameters P1 and P30 is generated using the uniform distribution, although the values may be generated as having other distributions such as Gaussian distribution, Poisson distribution, or the like. In the uniform distribution, assuming parameter P1 (or any other parameter P2 through P30) has value ranging from 20 to 30, the 10,000 P1 values are uniformly distributed between 20 and 30. With the uniform distribution of input parameters P1 through P30, the corner cases that have smaller possibility to occur in other distributions (such as Gaussian distribution) are more likely to occur, and the resulting distribution (which may be illustrated using line 52 in FIG. 10, for example) will be more accurate.

Referring to FIG. 2, small-sample input parameter sets 24 are provided to Monte Carlo simulation model 26 to run Monte Carlo simulations, so that output parameter values 30 (referred to as simulated Icell values 30 hereinafter) are generated. In an exemplary embodiment in which small-sample input parameter sets 24 include 10,000 input parameter sets, there will be 10,000 simulated Icell values. Monte Carlo simulation model 26 is also schematically expressed as Equation 1 (although the actually relationship between parameters P1 through P30 and Icell may be more complicated in simulation model 26):

Icell=FM(P1,P2 . . . P30) [Eq. 1]

Wherein “FM” represents that output parameter Icell is the function FM of parameters P1 through P30. Since small-sample input parameter sets 24 are relatively small, the Monte Carlo simulation as shown in FIG. 2 takes a relatively small amount of time to finish. Since each of simulated Icell values 30 is generated through one of the small-sample input parameter sets 24, there is a one-to-one mapping between small-sample input parameter sets 24 and simulated Icell values 30.

Simulated Icell values 30 as shown in FIG. 2 is plotted in FIG. 3, wherein the minimum value and the maximum value of simulated Icell values 30 are Imin and Imax, respectively. The range from Imin to Imax are then divided into a plurality of sub-ranges, namely R1 through RL, with sub-range R1 and RL being the first and the last sub-range, respectively. In each of the sub-ranges, there is a plurality of simulated Icell values 30 falling into the sub-range. The simulated Icell values 30 are symbolized as dots.

Next, each of the sub-ranges is processed separately. For example, in the first sub-range R1, which may be between Icell values Imin and Icell1, there may be 50 Icell values. Since these 50 Icell values correspond to 50 small-sample input parameter sets, a fitting may be performed to generate an equation expressing output parameter Icell as function FA of input parameters P1 through P30:

Icell=FA(P1,P2 . . . P30) [Eq. 2]

The generation of Equation 2 may be performed using response surface methodology (RSM) or other methods.

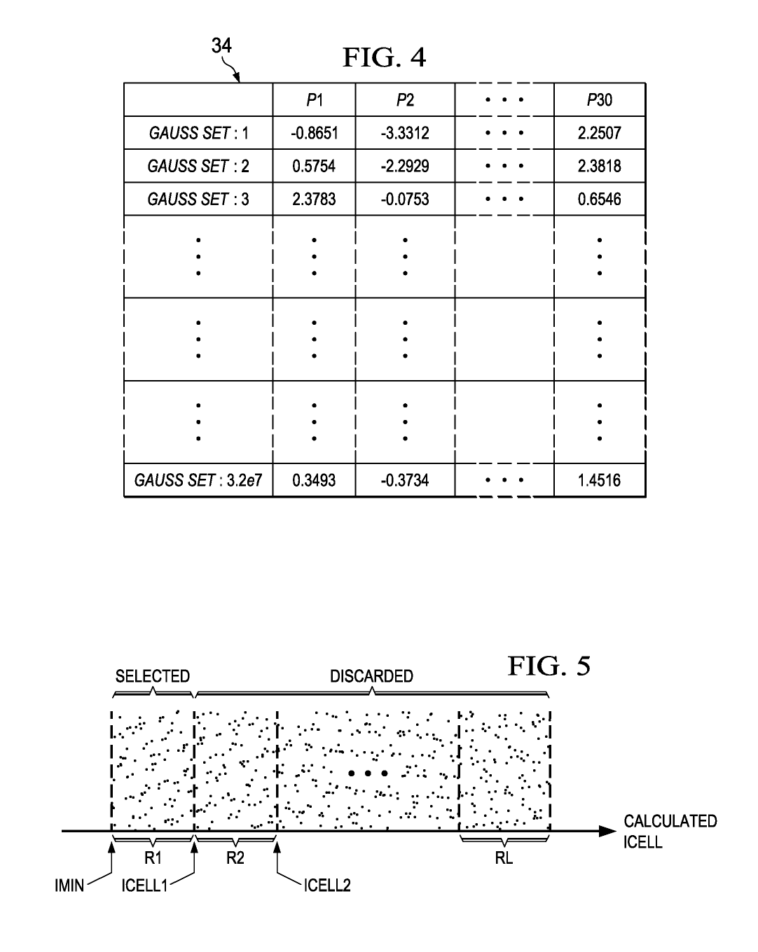

Referring to FIG. 4, second plurality of input parameter sets 34 (denoted as GAUSS set 1 through GAUSS set 3.2e7) is generated. Throughout the description, second input parameter sets 34 are referred to large-sample input parameter sets due to the relatively large size. The size of large-sample input parameter sets 34 may be many times greater than small-sample input parameter sets 24 as in FIG. 1. In the discussed exemplary embodiment, there are 32 million (32e7) large-sample input parameter sets, although the count of large-sample input parameter sets may be greater or smaller. The 32 million large-sample input parameter sets 34 may correspond to a simulated SRAM memory circuit comprising 32 million SRAM cells. In an exemplary embodiment, each of parameters P1 and P30 in large-sample input parameter sets 34 is generated using Gaussian distribution, although they may be generated as having other distributions. In an embodiment, large-sample input parameter sets 34 are less uniform than small-sample input parameter sets 24.

Each of large-sample input parameter sets 34 is used to calculate an output parameter Icell value using Equation 2. Since Equation 2 is a simple equation, the calculation may be finished in a short period of time. Accordingly, 32 million output parameter Icell values are generated. The resulting output parameter Icell values are referred to as calculated Icell values hereinafter. The calculated 32 million Icell values are schematically shown in FIG. 5. It is expected that the calculated Icell values fall into substantially the same Icell range as in FIG. 3, which range can also be divided into sub-ranges R1 through RL. The calculated Icell values fall into different sub-ranges R1 through RL.

It is observed that there is a plurality of the calculated Icell values falling into sub-range R1, while remaining ones of the calculated Icell values fall out of sub-range R1. In the embodiments, the calculated Icell values falling into sub-range R1 is selected, while the remaining calculated Icell values falling out of sub-range R1 are discarded.

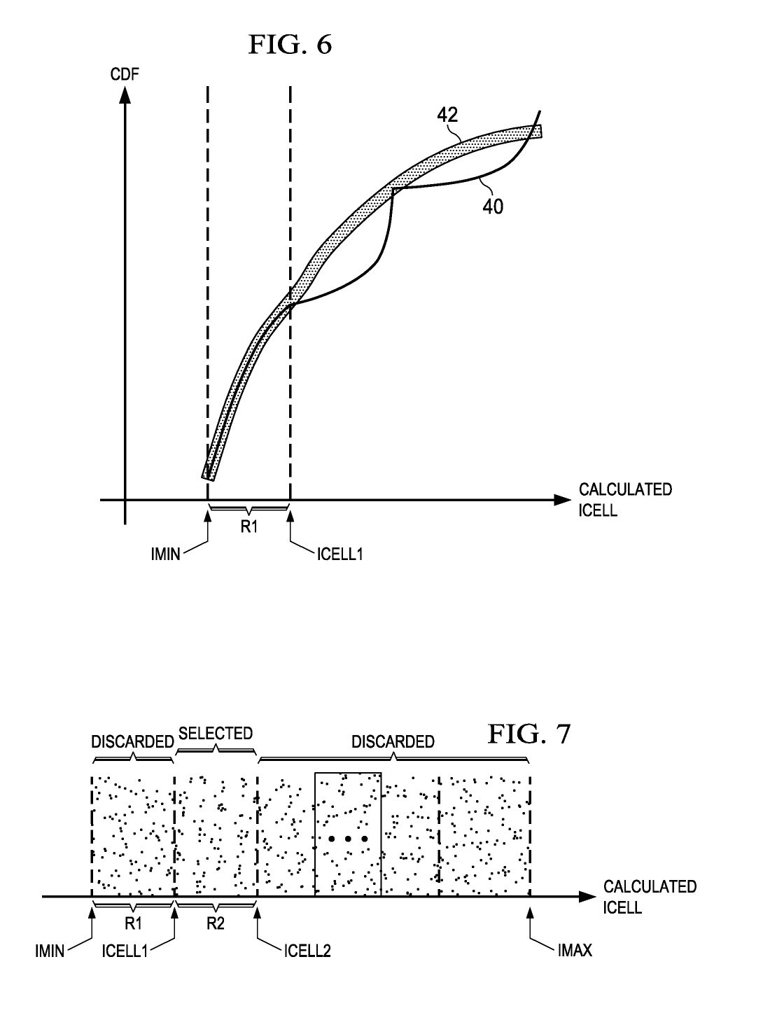

FIG. 6 illustrates cumulative density function (CDF) as a function of the calculated Icell values, wherein the CDF is shown as line 40. FIG. 6 also illustrates line 42, which is an ideal line that would be obtained if Monte Carlo simulations are performed on the 32 million large-sample input parameter sets 34 using model 26 shown in FIG. 2, and the resulting 32 million output parameter Icell values will be drawn as line 42. It is observed that in Icell sub-range R1, lines 40 and 42 substantially overlap each other. This indicates that the distribution of output parameter Icell in sub-range R1 is accurate.

Referring back to FIG. 3, in the second sub-range R2, which may be between Icell values Icell1 and Icell2, there is a plurality of (such as 55) simulated Icell values 30 falling into sub-range R2. Since these 55 output parameter Icell values correspond to 55 small-sample input parameter sets 24 (FIG. 1), a fitting may be performed to generate an equation expressing output parameter Icell as function FB of input parameters P1 through P30, as shown below:

Icell=FB(P1,P2 . . . P30) [Eq. 3]

Each of large-sample input parameter sets 34 as in FIG. 4 is then used to calculate an output parameter Icell using Equation 3. Since Equation 3 is also a simple equation, the calculation may be finished quickly. Accordingly, 32 million output parameter Icell values are generated. The resulting 32 output parameter Icell values (also refer to as calculated Icell values hereinafter) are schematically plotted in FIG. 7 as dots. It is observed there is a plurality of calculated Icell values falling into sub-range R2, while remaining calculated Icell values fall out of sub-range R2. In the embodiments, the calculated Icell values falling into sub-range R2 are selected and are kept, while the remaining calculated Icell values falling out of sub-range R2 are discarded.

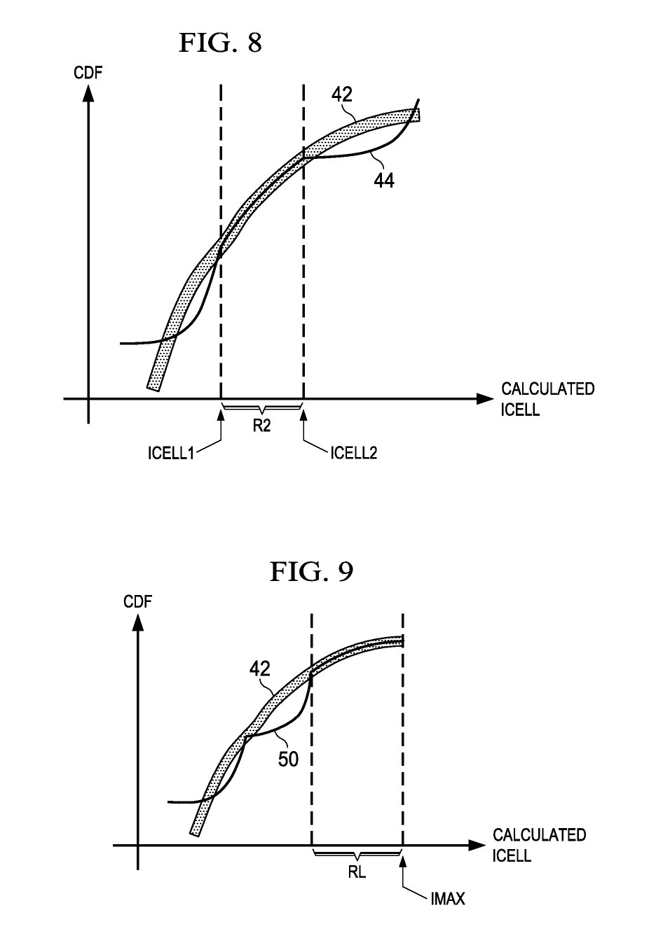

FIG. 8 illustrates CDF as a function of the calculated Icell values obtained through the calculation using Equation 3, wherein the CDF is shown as line 44. It is observed that in output parameter Icell sub-range R2, lines 44 and 42 substantially overlap each other. In remaining sub-ranges, lines 42 and 44 may not overlap each other.

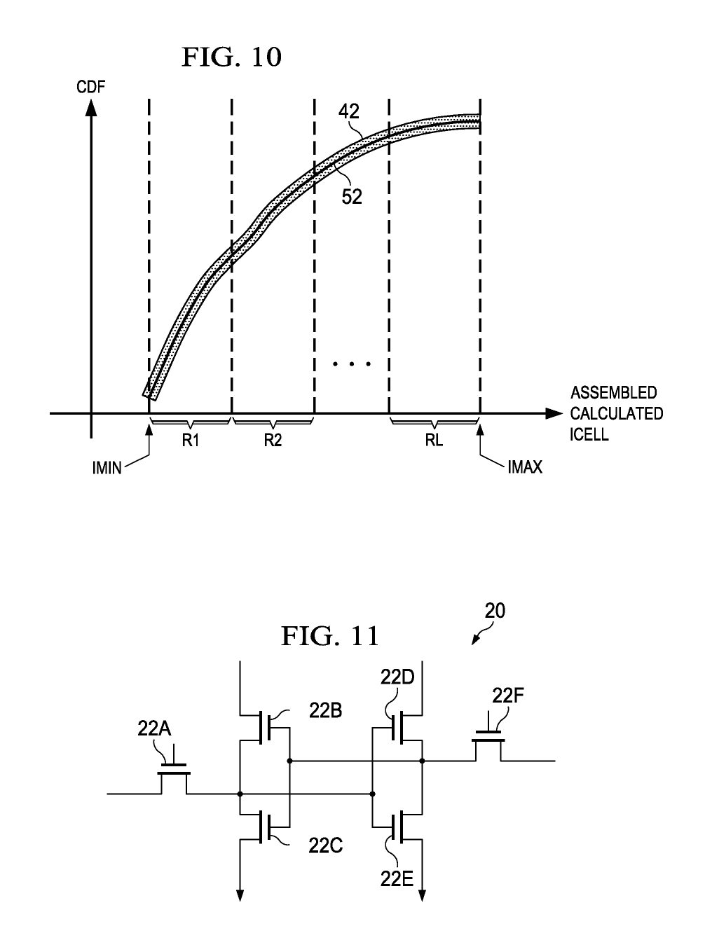

The similar steps including selecting a sub-range from FIG. 3, generating an equation similar to equations 2 and 3, calculating Icell values as shown in FIGS. 5 and 6 (or FIGS. 7 and 8), and selecting the respective calculated Icell values that fall into the respective sub-ranges are repeated for each of the remaining sub-ranges R3 through RL in FIG. 3. FIG. 9 schematically illustrates the result of the last sub-range RL, wherein line 50 represents the distribution of the calculated Icell values. Again, output parameter Icell values shown in FIG. 9 are calculated using Equation 4, which is generated by fitting the simulated Icell values in sub-range RL in FIG. 3:

Icell=FC(P1,P2 . . . P30) [Eq. 4]

Similarly, only those calculated Icell values obtained from sub-range RL are selected, while the remaining calculated Icell values are discarded. It is also observed that in FIG. 9, lines portions of lines 42 and 50 in sub-range RL overlap each other, while portion line portions outside of sub-range RL may not overlap.

When all of the sub-ranges R1 through RL have been processed, in the entire range from Imin through Imax as in FIG. 3, the selected ones of the calculated Icell values as shown in FIGS. 5 through 9 are assembled. The assembled calculated Icell values are schematically illustrated in FIG. 10, wherein the CDF is shown as a function of the assembled calculated Icell values. The Icell values in sub-range R1 is from FIG. 5, the values data in sub-range R2 include the data selected from FIG. 7 (and also include the Icell values in sub-range R1), the Icell data in sub-range RL include the data selected from FIG. 9, and so on, and the assembled Icell values form line 52. Experimental results have shown that the resulting line 52 fits line 42 well, wherein line 42 is generated in the experiments.

In the embodiments, the time-consuming Monte Carlo simulation is performed to the small-sample input parameter sets, not to the large-sample input parameter sets. The calculation using the large-sample input parameter sets, on the other hand, is very fast. Accordingly, the entire simulation process may be shortened from months that are needed by conventional Monte Carlo simulations (which are performed on large-sample input parameter sets) to a matter of a day or two. Experiment results have shown that the results, as shown as line 52 in FIG. 10, fit the large-sample Monte Carlo simulation results well.

In accordance with embodiments, a method includes providing an integrated circuit device comprising a plurality of input parameters and an electrical parameter. A simulation is performed using a simulation model to simulate a plurality of data of the electrical parameter, wherein the plurality of data are generated through simulation from a first plurality of input parameter sets reflecting values of the plurality of input parameters, and wherein the plurality of data is distributed in a range. A first sub-range among the range is selected. All of the plurality of data falling into the first sub-range are selected, and are fitted with corresponding ones of the first input parameter sets to generate a first function, wherein the electrical parameter is expressed as the first function of the plurality of input parameters. The first function is different from functions in the simulation model.

In accordance with other embodiments, a method includes providing an integrated circuit device comprising a plurality of input parameters and an electrical parameter affected by the plurality of input parameters. A first plurality of input parameter sets of the plurality of input parameters is generated. A second plurality of input parameter sets of the plurality of input parameters is generated. Monte Carlo simulations are performed to generate a plurality of data of the electrical parameter from the first plurality of input parameter sets, wherein the plurality of data is distributed in a range. The range is divided into a plurality of sub-ranges. A sub-range is selected from the plurality of sub-ranges, and the follow process steps are performed. All of the plurality of data falling into the sub-range are chosen, and are fitted with corresponding ones of the first input parameter sets to generate an equation. Substantially none of the data falling out of the sub-range is chosen. In the equation, the electrical parameter is expressed as a function of the plurality of input parameters. A plurality of circuit parameter values is calculated by providing the second plurality of input parameter sets into the equation, with each of the plurality of circuit parameter values calculated using one of the second plurality of input parameter sets. The plurality of circuit parameter values falling into the sub-range is selected, while the plurality of circuit parameter values falling out of the sub-range is discarded. The steps starting from the step of selecting the sub-range to the step of selecting the plurality of circuit parameter values are repeated for all of the plurality of sub-ranges.

In accordance with yet other embodiments, a method includes providing an integrated circuit device comprising a plurality of input parameters and an electrical parameter, wherein the plurality of input parameters comprises layout parameters. Small-sample input parameter sets and large-sample input parameter sets of the plurality of input parameters are generated. Simulations are performed to generate values of the electrical parameter from the small-sample input parameter sets, and to obtain a distribution range of the electrical parameter. A plurality of equations corresponding to a plurality of sub-ranges in the distribution range is generated, wherein the step of generating comprises performing Monte Carlo simulations, wherein in each of the plurality of equations, the electrical parameter is expressed as a function of the plurality of input parameters, and wherein the plurality of equations is different from each other. A distribution of the electrical parameter is generated from the plurality of equations.

Although the embodiments and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A method comprising:
providing an integrated circuit device comprising a plurality of input parameters and an electrical parameter;
performing a simulation using a simulation model to simulate a plurality of data of the electrical parameter, wherein the plurality of data are generated through simulation from a first plurality of input parameter sets reflecting values of the plurality of input parameters, and wherein the plurality of data is distributed in a range;
selecting a first sub-range among the range;
choosing all of the plurality of data falling into the first sub-range; and
fitting the all of the plurality of data falling into the first sub-range with corresponding ones of the first input parameter sets to generate a first function, wherein the electrical parameter is expressed as the first function of the plurality of input parameters, and wherein the first function is different from functions in the simulation model.

2. The method of claim 1 further comprising:
selecting a second sub-range among the range of the electrical parameter, wherein the second sub-range does not overlap the first sub-range;
choosing all of the plurality of data falling into the second sub-range; and
fitting the all of the plurality of data falling into the second sub-range with corresponding ones of the first input parameter sets to generate a second function, wherein the electrical parameter is expressed as the second function of the plurality of input parameters.

3. The method of claim 2 further comprising:
dividing the range of the electrical parameter into a plurality of sub-ranges, with the first and the second sub-ranges being among the plurality of sub-ranges, wherein the step of choosing and the step of fitting are repeated for each of the plurality of sub-ranges to generate a plurality of functions different from each other.

4. The method of claim 1 further comprising:
generating a second plurality of input parameter sets of the plurality of input parameters; and
calculating a plurality of electrical parameter values from the second plurality of input parameter sets, wherein each of plurality of electrical parameter values is a value of the electrical parameter, and is calculated using the first function with one of the second plurality of input parameter sets as an input value.

5. The method of claim 4, wherein the first plurality of input parameter sets has a uniform distribution, and wherein the second plurality of input parameter sets has a Gaussian distribution.

6. The method of claim 4 further comprising:
constructing a new group of circuit parameter values by selecting electrical parameter values falling into the first sub-range as a part of the new group of circuit parameter values, and discarding the plurality of electrical parameter values falling out of the first sub-range.

7. The method of claim 6 further comprising:
dividing the range of the electrical parameter into a plurality of sub-ranges, with the first sub-range being one of the plurality of sub-ranges; and
repeating the step of choosing, the step of fitting, and the step of constructing for each of the plurality of sub-ranges to construct the new group of circuit parameter values, wherein the new group of circuit parameter values cover an entirety of the range.

8. The method of claim 1, wherein the plurality of input parameters comprises parameters selected from the group consisting essentially of gate oxide thicknesses of transistors, gate widths of the transistors, gate lengths of the transistors, and combinations thereof.

9. A method comprising:
providing an integrated circuit device comprising a plurality of input parameters and an electrical parameter affected by the plurality of input parameters;
generating a first plurality of input parameter sets of the plurality of input parameters;
generating a second plurality of input parameter sets of the plurality of input parameters;
performing Monte Carlo simulations to generate a plurality of data of the electrical parameter from the first plurality of input parameter sets, wherein the plurality of data is distributed in a range;
dividing the range into a plurality of sub-ranges;
selecting a sub-range from the plurality of sub-ranges, and performing process steps of:
choosing all of the plurality of data falling into the sub-range, wherein substantially none of the data falling out of the sub-range is chosen;
fitting the all of the plurality of data falling into the sub-range with corresponding ones of the first input parameter sets to generate a first equation, wherein in the first equation, the electrical parameter is expressed as a function of the plurality of input parameters;
calculating a plurality of circuit parameter values by providing the second plurality of input parameter sets into the first equation, with each of the plurality of circuit parameter values calculated using one of the second plurality of input parameter sets; and
selecting the plurality of circuit parameter values falling into the sub-range, and discarding the plurality of circuit parameter values falling out of the sub-range; and
repeating steps starting from the step of selecting the sub-range to the step of selecting the plurality of circuit parameter values for all of the plurality of sub-ranges.

10. The method of claim 9 further comprising:
constructing a new group of circuit parameter values using selected values obtained in the step of selecting the plurality of circuit parameter values falling into the sub-range.

11. The method of claim 9, wherein the first plurality of input parameter sets has a first distribution different from a second distribution of the second plurality of input parameter sets.

12. The method of claim 11, wherein the first distribution is a uniform distribution.

13. The method of claim 12, wherein the second distribution is a Gaussian distribution.

14. The method of claim 9, wherein the plurality of input parameters are layout parameters selected from the group consisting essentially of gate oxide thicknesses of transistors in a static random access memory (SRAM) cell, gate widths of the transistors, gate lengths of the transistors, and combinations thereof, and the electrical parameter is a cell current of the SRAM cell.

15. A method comprising:
providing an integrated circuit device comprising a plurality of input parameters and an electrical parameter, wherein the plurality of input parameters comprises layout parameters;
generating small-sample input parameter sets of the plurality of input parameters;
generating large-sample input parameter sets of the plurality of input parameters, wherein the large-sample input parameter sets are greater in size than the small-sample input parameter sets;
simulating to generate values of the electrical parameter from the small-sample input parameter sets to obtain a distribution range of the electrical parameter;
generating a plurality of equations corresponding to a plurality of sub-ranges in the distribution range, wherein the step of generating comprises performing Monte Carlo simulations, wherein in each of the plurality of equations, the electrical parameter is expressed as a function of the plurality of input parameters, and wherein the plurality of equations is different from each other; and
generating a distribution of the electrical parameter from the plurality of equations.

16. The method of claim 15, wherein the step of generating the distribution of the electrical parameter comprises, for each of the plurality of equations:
calculating a plurality of electrical parameter values of the electrical parameter from the large-sample input parameter sets using the each of the plurality of equations, with each of plurality of electrical parameter values calculated using one of the large-sample input parameter sets.

17. The method of claim 15, wherein the step of simulating comprises Monte Carlo simulations, wherein the step of generating each of the plurality of equations comprises, for each of the plurality of sub-ranges, selecting the values of the electrical parameter falling into the each of the sub-ranges, wherein the values of the electrical parameter not falling into the each of the sub-ranges is not used in the step of generating the each of the plurality of equations.

18. The method of claim 15, wherein the small-sample input parameter sets have a first distribution more uniform than a second distribution of the large-sample input parameter sets.

19. The method of claim 18, wherein the second distribution is a Gaussian distribution.

20. The method of claim 19, wherein the first distribution is a uniform distribution.
